(19) United States
(12) Patent Application Publication
(10) Pub. No.: US 2025/0056118 A1
(43) Pub. Date: Feb. 13, 2025

(54) FOCUS DETECTION APPARATUS AND METHOD, ELECTRONIC DEVICE, AND STORAGE MEDIUM

(71) Applicant: CANON KABUSHIKI KAISHA, Tokyo (JP)

(72) Inventors: Hirotaro KIKUCHI, Tokyo (JP); Koichi FUKUDA, Tokyo (JP)

(21) Appl. No.: 18/792,628

(22) Filed: Aug. 2, 2024

(30) Foreign Application Priority Data
Aug. 10, 2023 (JP) 2023-131462

(51) Int. Cl. H04N 23/67; H04N 23/80; H04N 25/42; H04N 25/44

(52) U.S. Cl. CPC H04N 23/672; H04N 23/80; H04N 25/42; H04N 25/44

(57) ABSTRACT

A focus detection apparatus comprising: an acquisition unit that acquires a pair of focus detection signals having parallax in one of a plurality of different directions for each pixel from signals of a plurality of pixels output from an image sensor; a separation unit that separates the focus detection signals for each of the directions of the parallax; a detection unit that detects a focus state based on first focus detection signals having parallax in a predetermined first direction; and a rearrangement unit that rearranges second focus detection signals having parallax in a predetermined second direction which is different from the first direction so as to change the direction of the parallax of the second focus detection signals to the first direction. The detection unit further detects a focus state based on the rearranged second focus detection signals.

### BACKGROUND OF THE INVENTION

### Field of the Invention

The present invention relates to a focus detection apparatus and method, electronic device, and storage medium

### Description of the Related Art

One of the focus detection methods used in image capturing apparatuses is a so-called on-imaging plane phase difference method, in which at least a part of the pixels of an image sensor are configured as focus detection pixels formed so as to be able to acquire signals having a phase difference, thereby performing phase difference focus detection. As an example of focus detection pixels for such on-imaging plane phase difference focus detection (hereinafter referred to as “on-imaging plane phase difference AF”), Japanese Patent Laid-Open No. 58-24105 discloses an image capturing apparatus using an image sensor in which a plurality of pixels are arranged in two dimensions wherein each pixel is formed with one microlens and a plurality of photoelectric conversion units. The plurality of photoelectric conversion units are configured to receive light transmitted through different exit pupil regions of an imaging lens through one microlens, thereby pupil division is realized. The on-imaging plane phase difference AF can be performed by calculating the image shift amount based on the phase difference between the signals obtained from the plurality of photoelectric conversion units. Also, an image can be acquired from an added signal obtained by adding up the signals of the plurality of photoelectric conversion units for each pixel.

In such an image sensor, if the image sensor has a configuration in which the plurality of photoelectric conversion units are arranged horizontally in each pixel and the pupil division direction is horizontal, in a case where the subject has no change in brightness in the horizontal direction, such as horizontal stripes, the phase difference between signals will be very small, and the focus detection accuracy may be low.

In consideration of the above, Japanese Patent No. 5810196 discloses a technique for improving focus detection accuracy by arranging the photoelectric conversion units of focus detection pixels in two directions, so that the pupil division directions are two. Also, U.S. Pat. No. 9,485,442 discloses a method in which focus detection calculation is performed separately for signals having different pupil division directions.

Here, an arithmetic circuit for focus detection that is configured on the premise of processing a pair of focus detection signals obtained from photoelectric conversion units divided in a certain pupil division direction (e.g., the horizontal direction) cannot process a pair of focus detection signals obtained from photoelectric conversion units divided in a different pupil division direction (e.g., the vertical direction).

### SUMMARY OF THE INVENTION

The present invention has been made in consideration of the above situation, and processes focus detection signals having parallax in a plurality of different directions using one arithmetic circuit for focus detection.

According to the present invention, provided is a focus detection apparatus comprising one or more processors and/or circuitry which function as: an acquisition unit that acquires a pair of focus detection signals having parallax in one of a plurality of different directions for each pixel from signals of a plurality of pixels output from an image sensor; a separation unit that separates the focus detection signals for each of the directions of the parallax; a detection unit that detects a focus state based on first focus detection signals, separated by the separation unit, having parallax in a predetermined first direction; and a rearrangement unit that rearranges second focus detection signals, separated by the separation unit, having parallax in a predetermined second direction which is different from the first direction so as to change the direction of the parallax of the second focus detection signals to the first direction, wherein the detection unit further detects a focus state based on the second focus detection signals rearranged by the rearrangement unit.

Further, according to the present invention, provided is a focus detection apparatus comprising one or more processors and/or circuitry which function as: a generation unit that generates a pair of first focus detection signals having parallax in one of a plurality of different directions for each pixel from signals of a plurality of pixels output from an image sensor; a detection unit that detects a focus state based on the first focus detection signals in a case where a direction of the parallax is a predetermined first direction; and a rearrangement unit that rearranges the first focus detection signals to generate second focus detection signals having parallax in the first direction in a case where the direction of the parallax of the first focus detection signals is a second direction which is different from the first direction, wherein the detection unit further detects a focus state based on the second focus detection signals.

Furthermore, according to the present invention, provided is an electronic device comprising: an image sensor; and a focus detection apparatus comprising one or more processors and/or circuitry which function as: an acquisition unit that acquires a pair of focus detection signals having parallax in one of a plurality of different directions for each pixel from signals of a plurality of pixels output from an image sensor; a separation unit that separates the focus detection signals for each of the directions of the parallax; a detection unit that detects a focus state based on first focus detection signals, separated by the separation unit, having parallax in a predetermined first direction; and a rearrangement unit that rearranges second focus detection signals, separated by the separation unit, having parallax in a predetermined second direction which is different from the first direction so as to change the direction of the parallax of the second focus detection signals to the first direction, wherein the detection unit further detects a focus state based on the second focus detection signals rearranged by the rearrangement unit.

Further, according to the present invention, provided is an electronic device comprising: an image sensor; and a focus detection apparatus comprising one or more processors and/or circuitry which function as: a generation unit that generates a pair of first focus detection signals having parallax in one of a plurality of different directions for each pixel from signals of a plurality of pixels output from an image sensor; a detection unit that detects a focus state based on the first focus detection signals in a case where a direction of the parallax is a predetermined first direction; and a rearrangement unit that rearranges the first focus detection signals to generate second focus detection signals having parallax in the first direction in a case where the direction of the parallax of the first focus detection signals is a second direction which is different from the first direction, wherein the detection unit further detects a focus state based on the second focus detection signals.

Further, according to the present invention, provided is a focus detection method comprising: acquiring a pair of focus detection signals having parallax in one of a plurality of different directions for each pixel from signals of a plurality of pixels output from an image sensor; separating the focus detection signals for each of the directions of the parallax; detecting a focus state based on separated first focus detection signals having parallax in a predetermined first direction; rearranging separated second focus detection signals having parallax in a predetermined second direction which is different from the first direction so as to change the direction of the parallax of the second focus detection signals to the first direction; and detecting a focus state based on the rearrangement second focus detection signals.

Further, according to the present invention, provided is a focus detection method comprising: generating a pair of first focus detection signals having parallax in one of a plurality of different directions for each pixel from signals of a plurality of pixels output from an image sensor; rearranging the first focus detection signals to generate second focus detection signals having parallax in the first direction in a case where the direction of the parallax of the first focus detection signals is a second direction which is different from the first direction; detecting a focus state based on the first focus detection signals in a case where a direction of the parallax is the first direction, and detecting a focus state based on the second focus detection signals in a case where a direction of the parallax is the second direction.

Further, according to the present invention, provided is a non-transitory computer-readable storage medium, the storage medium storing a program that is executable by the computer, wherein the program includes program code for causing the computer to function as a focus detection apparatus comprising: an acquisition unit that acquires a pair of focus detection signals having parallax in one of a plurality of different directions for each pixel from signals of a plurality of pixels output from an image sensor; a separation unit that separates the focus detection signals for each of the directions of the parallax; a detection unit that detects a focus state based on first focus detection signals, separated by the separation unit, having parallax in a predetermined first direction; and a rearrangement unit that rearranges second focus detection signals, separated by the separation unit, having parallax in a predetermined second direction which is different from the first direction so as to change the direction of the parallax of the second focus detection signals to the first direction, wherein the detection unit further detects a focus state based on the second focus detection signals rearranged by the rearrangement unit.

Further, according to the present invention, provided is a non-transitory computer-readable storage medium, the storage medium storing a program that is executable by the computer, wherein the program includes program code for causing the computer to function as a focus detection apparatus comprising: a generation unit that generates a pair of first focus detection signals having parallax in one of a plurality of different directions for each pixel from signals of a plurality of pixels output from an image sensor; a detection unit that detects a focus state based on the first focus detection signals in a case where a direction of the parallax is a predetermined first direction; and a rearrangement unit that rearranges the first focus detection signals to generate second focus detection signals having parallax in the first direction in a case where the direction of the parallax of the first focus detection signals is a second direction which is different from the first direction, wherein the detection unit further detects a focus state based on the second focus detection signals.

Further features of the present invention will become apparent from the following description of exemplary embodiments (with reference to the attached drawings).

### BRIEF DESCRIPTION OF THE DRAWINGS

The accompanying drawings, which are incorporated in and constitute a part of the specification, illustrate embodiments of the invention, and together with the description, serve to explain the principles of the invention.

FIG. 1 is a block diagram illustrating a schematic configuration of an image capturing apparatus according to an embodiment of the present invention;

FIG. 2 is a schematic diagram illustrating an example of a pixel array according to a first embodiment;

FIGS. 3A and 3B are a schematic plan view and a cross-sectional view, respectively, of a pixel according to the first embodiment;

FIG. 4 is a schematic explanatory view of a pixel structure and pupil division according to the first embodiment;

FIG. 5 is a schematic diagram illustrating the pupil division of the exit pupil according to the first embodiment;

FIG. 6 is a diagram illustrating a relationship between a defocus amount and an image shift amount according to the first embodiment;

FIG. 7 is a block diagram showing a configuration of an image processing circuit according to the first embodiment;

FIGS. 8A to 8C are conceptual diagrams of focus detection signals according to the first embodiment;

FIGS. 9A and 9B are conceptual diagrams of row interpolation processing according to the first embodiment;

FIGS. 10A and 10B are conceptual diagrams of rearrangement processing according to the first embodiment;

FIGS. 11A to 11C are diagrams illustrating an example of processing in which a vertical focus detection signal array is transposed to match with the pupil division direction of a horizontal focus detection signal array;

FIG. 12 is a flowchart illustrating focus detection processing according to the first embodiment;

FIG. 13 is a flowchart illustrating focus detection processing according to a second embodiment;

FIG. 14 is a schematic diagram illustrating an example of a pixel array according to a third embodiment;

FIG. 15 is a conceptual diagram of a focus detection signal generated in the third embodiment;

FIGS. 16A and 16B are conceptual diagrams of rearrangement processing according to the third embodiment;

FIG. 17 is a block diagram illustrating a configuration of an image processing circuit according to the third embodiment; and

FIG. 18 is a flowchart illustrating focus detection processing according to the third embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

### [Overall Configuration]

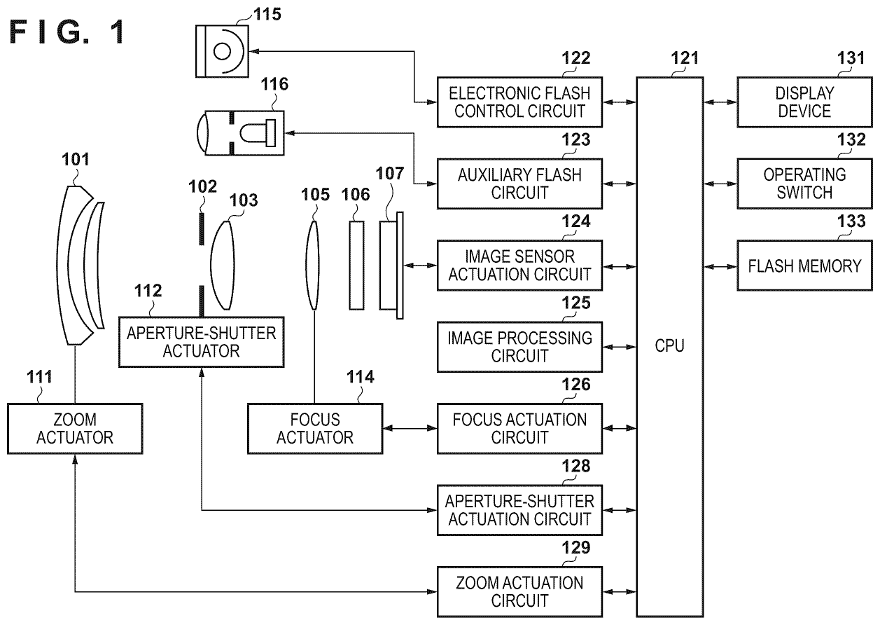

FIG. 1 is a block diagram showing the schematic configuration of a single-lens reflex digital camera with interchangeable lenses as an image capturing apparatus having an image sensor according to an embodiment of the present invention. Note that in this embodiment, a specific configuration is provided to facilitate understanding and explanation of the invention, but the present invention is not limited to such a specific configuration. In addition, the present invention can also be implemented in, for example, a digital camera with an integrated lens, a video camera, or any electronic device equipped with a camera, such as a mobile phone, a personal computer (laptop, tablet, desktop, etc.), or a game console.

In FIG. 1, a first lens group 101 is disposed on the front end of an imaging optical system, and supported so as to be movable forward and backward along an optical axis. An aperture-shutter 102 adjusts the diameter of its opening, thereby adjusting the amount of light during image shooting, and also has a function to adjust the exposure period during still image shooting. The aperture-shutter 102 and a second lens group 103 move together forward and backward along the optical axis, and, in conjunction with the forward and backward movement of the first lens group 101, provide a magnification change effect (a zoom function).

A third lens group 105 (focus lens) carries out focus adjustment by moving forward and backward along the optical axis. A low-pass optical filter 106 is an optical element for reducing false color and moiré of a sensed image. An image sensor 107 is composed of a two-dimensional CMOS photo sensor and the surrounding circuitry, and disposed on an imaging plane of the imaging optical system.

A zoom actuator 111 carries out a magnification-change operation by rotation of a cam barrel, not shown, to move the first lens group 101 through the second lens group 103 forward and backward along the optical axis. An aperture-shutter actuator 112 controls the diameter of the opening of the aperture-shutter 102 and adjusts the amount of light for image shooting, and also controls the exposure period during still image shooting. A focus actuator 114 moves the third lens group 105 forward and backward along the optical axis to adjust the focus.

As an electronic flash 115 for illuminating a subject during image shooting, a flash illumination device that uses a Xenon tube is preferable, but an illumination device comprised of a continuous-flash LED may also be used. An AF auxiliary flash unit 116 projects an image of a mask having a predetermined opening pattern onto a subject field through a projective lens to improve focus detection capability with respect to dark subjects and low-contrast subjects.

A CPU 121 controls the camera main body in various ways within the image capturing apparatus. The CPU 121 may, for example, have a calculation unit, ROM, RAM, A/D converter, D/A converter, communication interface circuitry, and so forth. In addition, the CPU 121, based on predetermined programs stored in the ROM, actuates the various circuits that the camera has, and executes a series of operations of AF, image shooting, image processing, and recording.

An electronic flash control circuit 122 controls light emission of the electronic flash 115 in synchronization with an image shooting operation. An auxiliary flash circuit 123 controls firing of the AF auxiliary flash unit 116 in synchronization with a focus detection operation. An image sensor actuation circuit 124 controls the image shooting operation of the image sensor 107 as well as A/D-converts an image signal read out from the image sensor 107 and transmits the converted image signal to the CPU 121. An image processing circuit 125 performs such processing as y conversion, color interpolation, JPEG compression and the like on an image signal acquired from the signal read out from the image sensor 107.

A focus actuation circuit 126 controls the actuation of the focus actuator 114 based on the focus detection result to move the third lens group 105 reciprocally in the optical axis direction, thereby performing focus adjustment. An aperture-shutter actuation circuit 128 controls the actuation of the aperture-shutter actuator 112, thereby actuating the opening of the aperture-shutter 102. A zoom actuation circuit 129 actuates the zoom actuator 111 in accordance with the zoom operation by the user.

A display device 131, such as an LCD, displays information relating to the image shooting mode of the camera, preview images before image shooting, confirmation images after image shooting, and focus state display images during focus detection, and so forth. An operating switch group 132 is composed of a power switch, a release (image shooting trigger) switch, a zoom operation switch, an image shooting mode selection switch, and so on. A detachable flash memory 133 records captured images.

### [Image Sensor]

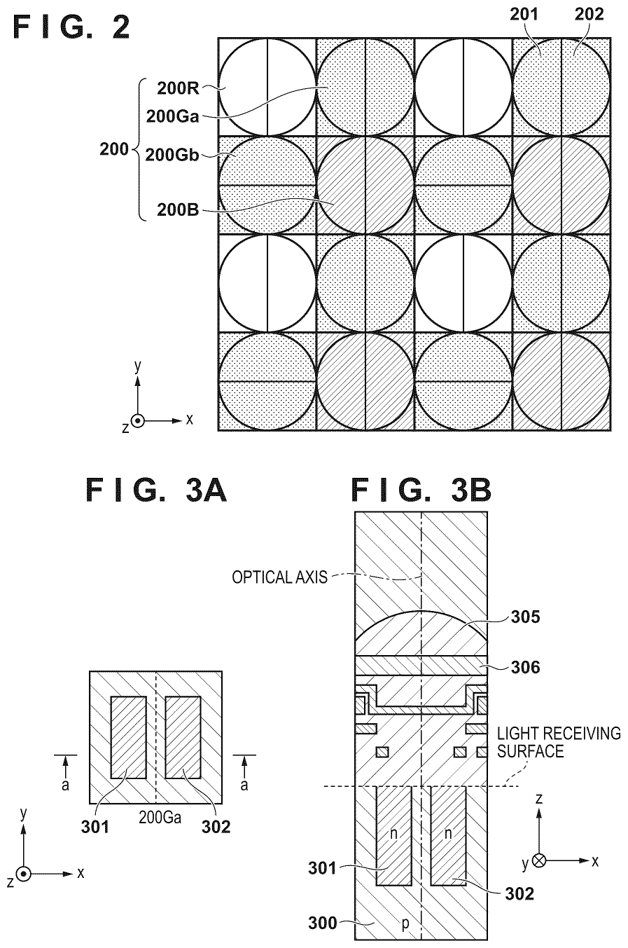

FIG. 2 shows the outline of an array of the imaging pixels and the focus detection pixels of the image sensor 107 according to the first embodiment. FIG. 2 illustrates the pixel (imaging pixel) array within the range of 4 columns×4 rows in the two-dimensional CMOS sensor according to the first embodiment.

A pixel group 200 includes pixels of 2 columns×2 rows, and a pixel 200R having an R (red) spectral sensitivity is arranged at the upper left position, a pixel 200Ga having a G (green) spectral sensitivity is arranged at the upper right position, a pixel 200Gb having a structure of the pixel 200Ga rotated by 90 degrees is arranged at lower left position, and a pixel 200B having a B (blue) spectral sensitivity is arranged at the lower right position. Each of the pixels 200R, 200Ga and 200B is formed from a first focus detection pixel 201 and a second focus detection pixel 202 arrayed in 2 columns×1 row, and the pixel 200Gb is formed from the first focus detection pixel 201 and the second focus detection pixel 202 arrayed in 1 column×2 rows.

A number of the pixel groups each having the array of 2 (columns)×2 (rows) pixels shown in FIG. 2 are arranged on a plane to enable to capture an image and focus detection signals.

FIG. 3A is a plan view of one pixel 200Ga of the image sensor 107 shown in FIG. 2 when viewed from the light receiving surface side (+z side) of the image sensor 107, and FIG. 3B is a sectional view taken along a-a in FIG. 3A viewed from the −y side. As shown in FIGS. 3A and 3B, in the pixel 200Ga according to this embodiment, a microlens 305 for converging incident light is formed on the light receiving side of each pixel. Photoelectric conversion units 301 and 302 that divide the pixel by NH (here, divided by two) in the x direction and by NV (here, divided by one) in the y direction are formed. The photoelectric conversion units 301 and 302 correspond to the first focus detection pixel 201 and the second focus detection pixel 202, respectively.

Each of the photoelectric conversion units 301 and 302 may be formed as a pin structure photodiode including an intrinsic layer between a p-type layer and an n-type layer or a p-n junction photodiode without an intrinsic layer, as needed.

In the pixel 200Ga, a color filter 306 is formed between the microlens 305 and the photoelectric conversion units 301 and 302. Furthermore, the spectral transmittance of the color filter 306 can be changed for each pixel or each photoelectric conversion unit, as necessary. Also, the color filter may be omitted.

Light that has entered the pixel 200Ga shown in FIGS. 3A and 3B is condensed by the microlens 305, spectrally split by the color filter 306, and received by the photoelectric conversion units 301 and 302. In the photoelectric conversion units 301 and 302, electron-hole pairs are produced in accordance with the received light amount and separated in the depletion layer. Electrons having negative charges are accumulated in the n-type layers (not shown). On the other hand, holes are discharged externally from the image sensor 107 through the p-type layers connected to a constant voltage source (not shown). The electrons accumulated in the n-type layers (not shown) of the photoelectric conversion units 301 and 302 are transferred to electrostatic capacitances (FDs) through transfer gates, converted into voltage signals, and output.

The pixels 200R and 200B shown in FIG. 2 also have the similar structure as the pixel 200Ga shown in FIGS. 3A and 3B, and output voltage signals corresponding to the light spectrally split by the color filter 306, in a similar manner as the pixel 200Ga. Further, the pixel 200Gb shown in FIG. 2 has a structure of the pixel 200Ga shown in FIGS. 3A and 3B rotated by 90 degrees, and outputs a voltage signal corresponding to the light spectrally split by the color filter 306, in a similar manner as the pixel 200Ga.

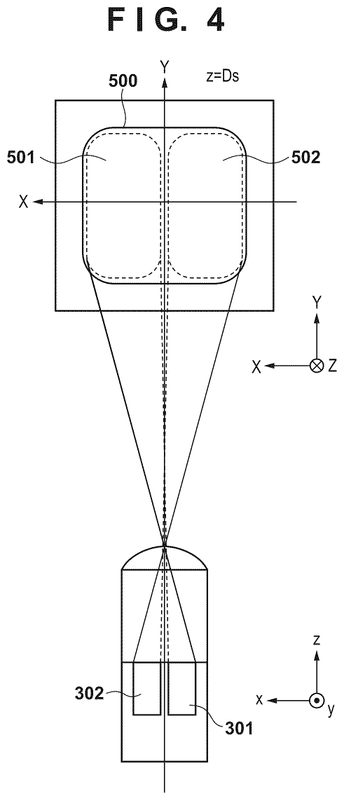

The correspondence between pupil division and the pixel structure according to this embodiment shown in FIGS. 3A and 3B will be described with reference to FIG. 4. Note that the pixels 200R, 200Ga, and 200B have the same configuration, and the pixel 200Gb has a structure of the pixel 200Ga rotated by 90 degrees, so the following description will be given using the pixel 200Ga as a representative example.

FIG. 4 illustrates a sectional view showing the a-a section of the pixel 200Ga shown in FIG. 3A viewed from the +y side and the pupil plane at a position separated by a distance Z (exit pupil distance Ds) in the z-axis direction (direction of the optical axis) from the imaging plane of the image sensor 107. Note that in FIG. 4, the x- and y-axes of the sectional view are reversed with respect to those of FIGS. 3A and 3B so as to take correspondence with the coordinate axes of the pupil plane.

A first partial pupil region 501 is almost conjugate with the light receiving surface of the photoelectric conversion unit 301 having a center of gravity decentered in the −x direction via the microlens 305, and represents a pupil region which passes light that can be received by the photoelectric conversion unit 301. The first partial pupil region 501 has a center of gravity decentered to the +x side on the pupil plane.

Further, a second partial pupil region 502 is almost conjugate with the light receiving surface of the photoelectric conversion unit 302 having a center of gravity decentered in the +x direction via the microlens 305, and represents a pupil region which passes light that can be received by the photoelectric conversion unit 302. The second partial pupil region 502 has a center of gravity decentered to the −x side on the pupil plane.

Further, a pupil region 500 is a pupil region which passes light that can be received by the photoelectric conversion units 301 and 302 of the entire pixel 200Ga.

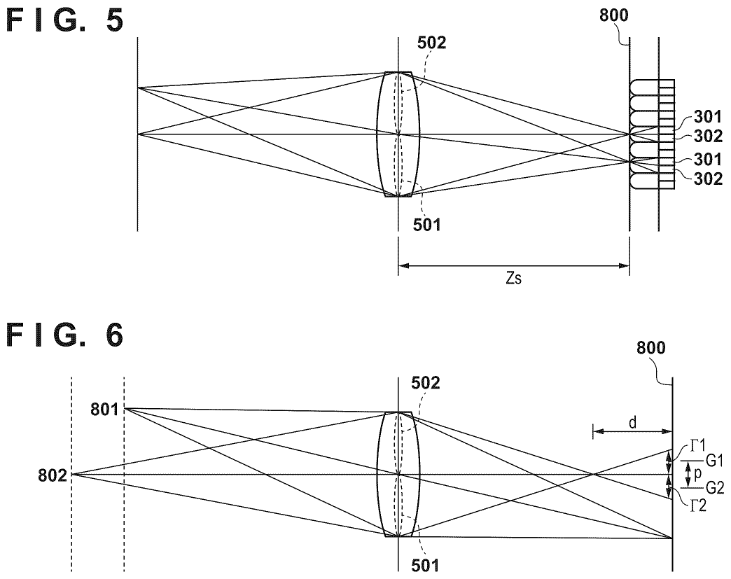

FIG. 5 is a schematic view showing the correspondence between the image sensor 107 and pupil division according to the embodiment. A pair of light fluxes that have passed through the different partial pupil regions of an imaging optical system, namely, the first partial pupil region 501 and the second partial pupil region 502 are incident on each pixel of the image sensor 107 at different incident angle corresponding to image height of each pixel, and received by the photoelectric conversion units 301 and 302 which are divided to 2×1. FIG. 5 shows the correspondence between the pupil region divided into two in the horizontal direction and the photoelectric conversion units 301 and 302 divided in the horizontal direction of the pixel 200Ga, the pixel 200R, and the pixel 200B. Although rotated by 90 degrees, the photoelectric conversion units 301 and 302 divided in the vertical direction of the pixel 200Gb has the similar correspondence as that of the pixel 200Ga.

In the following explanation, the pixels having the photoelectric conversion units 301 and 302 divided in the horizontal direction, such as the pixel 200Ga, pixel 200R, and pixel 200B, are referred to as “horizontally divided pixels.” Also, the pixels having the photoelectric conversion units 301 and 302 divided in the vertical direction, such as the pixel 200Gb, are referred to as “vertically divided pixels.”

As described above with reference to FIGS. 4 and 5, the photoelectric conversion unit 301 of each pixel receives a light flux that passes through the first partial pupil region 501 of the imaging optical system, and the photoelectric conversion unit 302 of each pixel receives a light flux that passes through the second partial pupil region 502 of the imaging optical system that is different from the first partial pupil region 501. Furthermore, if the photoelectric conversion unit 301 and the photoelectric conversion unit 302 of each pixel is combined, they receive a light flux that passes through a pupil region that is the combined first partial pupil region 501 and second partial pupil region 502 of the imaging optical system.

In the image sensor 107 of the present embodiment, each pixel is configured from the first focus detection pixel 201 including the photoelectric conversion unit 301 and the second focus detection pixel 202 including the photoelectric conversion unit 302, but the present invention is not limited to this. For example, an imaging pixel having an undivided photoelectric conversion unit, a first focus detection pixel, and a second focus detection pixel may each be configured as separate pixel configurations, and the first focus detection pixel and the second focus detection pixel may be discretely arranged in the imaging pixel array.

In each pixel having the configuration as explained with reference to FIGS. 2 to 5, a signal (signal A+B) obtained by adding signals obtained from the first focus detection pixel 201 and the second focus detection pixel 202 is used as an imaging signal, and the signals (signal A, signal B) obtained from the first focus detection pixel 201 and the second focus detection pixel 202, respectively, are used as a focus detection signal pair. Note that the imaging signal and the focus detection signals may be read out separately, but in consideration of the processing load, they may be acquired in the following way. That is, the imaging signal (signal A+B) and a focus detection signal (e.g., signal A) from either the first focus detection pixel 201 or the second focus detection pixel 202 are read out, and the difference is taken to acquire the other focus detection signal having parallax (e.g., signal B).

Then, a signal (hereinafter referred to as a “horizontal A image”) is generated by collecting A signals (hereinafter referred to as a “horizontal A signal”) from the horizontally divided pixels, and a signal (hereinafter referred to as a “horizontal B image”) is generated by collecting B signals (hereinafter referred to as a “horizontal B signal”) from the horizontally divided pixels. Then, focus detection is performed based on the phase difference between the generated horizontal A image and horizontal B image. Also, a signal (hereinafter referred to as a “vertical A image”) is generated by collecting A signals (hereinafter referred to as a “vertical A signal”) from the vertically divided pixels, and a signal (hereinafter referred to as a “vertical B image”) is generated by collecting B signals (hereinafter referred to as a “vertical B signal”) from the vertically divided pixels, and focus detection is performed based on the phase difference between the generated vertical A image and vertical B image. Note, in the following description, when describing processing common to the horizontal and vertical directions, the terms “A signal” and “B signal”, “A image” and “B image” are used.

### [Relationship Between Defocus Amount and Image Shift Amount]

Next, the relationship between a defocus amount and an image shift amount between the A image and the B image obtained from the image sensor 107 of this embodiment will be described. FIG. 6 is a diagram showing the relationship between the defocus amount and the image shift amount. The image sensor 107 of the present embodiment is arranged on an imaging surface 800, and the pupil region 500 of the imaging optical system is divided into two parts, i.e., the first partial pupil region 501 and the second partial pupil region 502, as in FIGS. 4 and 5.

Let the magnitude of a distance from an imaging position of a subject to the imaging surface 800 be |d|, then the defocus amount d is defined as a negative value (d<0) in a front-focused state in which the imaging position of the subject is closer to the subject than the imaging surface 800, and is defined as a positive value (d>0) in a rear-focused state in which the imaging position of the subject is on the opposite side of the subject with respect to the imaging surface 800. d=0 holds in a focus state in which the imaging position of the subject is at the imaging surface 800 (in-focus position). In FIG. 6, a subject 801 shows an example of the in-focus state (d=0), and a subject 802 shows an example of the front-focused state (d<0). Both of the front-focused state (d<0) and the rear-focused state (d>0) are called a defocus state (|d|>0).

In the front-focused state (d<0), subject light passed through the first partial pupil region 501 among the luminous flux from the subject 802 converges once, then spreads to the width Γ1 around the center of gravity position G1 of the luminous flux, and a blurred image is formed on the imaging surface 800. The same applies to the subject light that has passed through the second partial pupil region 502, and a blurred image spreading to the width Γ2 is formed around the center of gravity position G2. The blurred image is received by the first focus detection pixels 201 and the second focus detection pixels 202 constituting respective pixels arranged in the image sensor 107, and the A image and the B image are generated from the obtained photoelectric signals. Therefore, the A image and the B image are recorded as the subject image in which the object 802 is blurred in the widths Γ1 and Γ2 around the center of gravity positions G1 and G2 on the imaging surface 800.

As the magnitude |d| of the defocus amount d increases, the blur widths Γ1 and Γ2 of the subject image increase substantially proportionally. Similarly, the magnitude |p| of the image shift amount p (=the difference between the center of gravity positions G1 and G2 of the luminous fluxes) between the A image and the B image also increases roughly in proportion to the magnitude |d| of the defocus amount d as it increases. The similar relationship holds in the rear-focused state (d>0) although the image shift direction of the image of the subject between the first focus detection signal and the second focus detection signal is opposite to that in the front-focused state.

Thus, the image shift amount p calculated from the A image and the B image is roughly proportional to the defocus amount d, so the defocus amount d can be calculated from the image shift amount p by using a conversion coefficient that is calculated in advance based on the baseline length.

### [Image Processing Circuit]

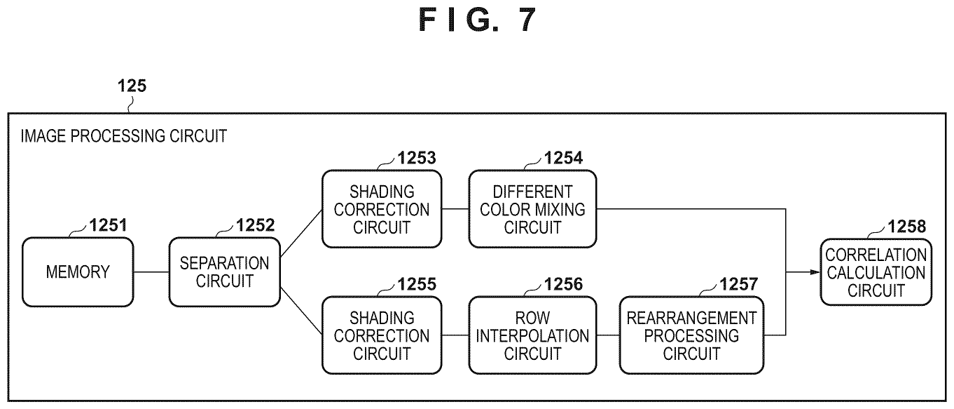

Next, the configuration of the image processing circuit 125 in this embodiment will be described with reference to FIG. 7. Here, the configuration that performs processing related to correlation calculations for focus detection, among the functions of the image processing circuit 125, will be described.

First, the A signals and the B signals obtained by reading out signals from image sensor 107 are stored in a memory 1251 in the image processing circuit 125.

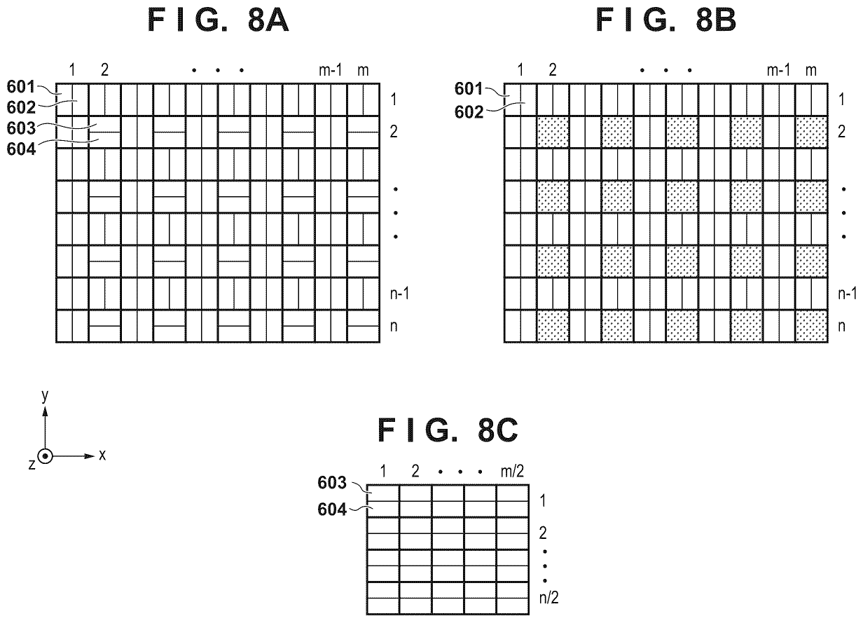

FIG. 8A is a conceptual diagram showing the signals obtained in a case where the pixels shown in FIG. 2 are arranged in m columns×n rows. As described above, the horizontally divided pixels and the vertically divided pixels are arranged in a mixed manner, so horizontal A signals 601 and horizontal B signals 602, and vertical A signals 603 and vertical B signals 604, which are divided in different directions, are obtained.

The A signals and B signals may be stored in a memory (not shown) that is normally provided in an image capturing apparatus, and read out by the image processing circuit 125 as needed.

Next, a separation circuit 1252 separates the first and second focus detection signals arranged as shown in FIG. 8A into the horizontal A signals 601 and the horizontal B signals 602, and the vertical A signals 603 and the vertical B signals 604.

FIG. 8B is a conceptual diagram in which the horizontal A signals 601 and the horizontal B signals 602 are separated from the signals shown in FIG. 8A, and FIG. 8C is a conceptual diagram in which the vertical A signals 603 and the vertical B signals 604 are separated from the signals shown in FIG. 8A. In the case of the image sensor 107 of this embodiment having the above-described configuration, the numbers of the vertical A signals 603 and the vertical B signals 604 in the row and column directions is ½ of the numbers of the horizontal A signals 601 and the horizontal B signals 602, respectively.

In addition, in the arrangement of the horizontal A signal 601 and the horizontal B signal 602 after separation as shown in FIG. 8B, the pixel values (shaded pixels) of the addresses where the vertical A signal 603 and the vertical B signal 604 were stored are interpolated from the pixel values of adjacent pixels. For example, in the case of the pixel arrangement shown in FIG. 2, the pixel values of the addresses where the vertical A signal 603 and the vertical B signal 604 from the pixel 200Gb are stored are replaced by the horizontal A signal 601 and the horizontal B signal 602 of the pixel 200Ga. Alternatively, in the different color mixing processing described later, they may be replaced by Y signals obtained by multiplying the horizontal A signal 601 and the horizontal B signal 602 from the pixel 200Ga by 2 and adding signals of other colors to the products, respectively.

Then, the horizontal A signal 601 and the horizontal B signal 602 are output to a shading correction circuit 1253, and the vertical A signal 603 and the vertical B signal 604 are output to a shading correction circuit 1255.

The shading correction circuit 1253 performs shading correction on the input horizontal A signal 601 and horizontal B signal 602.

The difference in the signal amount between the A signal and the B signal that occurs depending on the image height when the exit pupil distance and the pupil distance of the image sensor are different is called shading. It is known that good focus detection is possible by performing shading correction and reducing the difference between the A signal and the B signal. Note that, as the shading correction in this embodiment, a known method such as the method described in Japanese Patent Laid-Open No. 2016-57474 can be used, and therefore a detailed description will be omitted.

A different color mixing circuit 1254 performs different color mixing processing on the shading-corrected horizontal A signal 601 and horizontal B signal 602. In this embodiment, this processing involves smoothing processing in the correlation direction (horizontal direction) and adding processing of two or more pixels in the direction perpendicular to the correlation direction. First, by performing smoothing processing in the correlation direction (for example, with a 1-1 filter or a 1-2-1 filter), colors are mixed in the correlation direction, and then signals from two or more pixels are added in the direction perpendicular to the correlation direction to mix colors in the vertical direction, thereby generating a horizontal Y_{A} signal and a horizontal Y_{B} signal, respectively. This processing leaves the number of the horizontally divided pixels unchanged, and reduces the number of the horizontally divided pixels in the vertical direction to ½ or less.

A horizontal Y_{A} signal and a horizontal Y_{B} signal generated by the different color mixing circuit 1254 are sent to a correlation calculation circuit 1258. The correlation calculation circuit 1258 generates a horizontal A image and a horizontal B image from the horizontal Y_{A} signal and horizontal Y_{B} signal, and finds a correlation value by a known method while shifting the relative positions of the horizontal A image and the horizontal B image. The shift amount at which the correlation value showing the highest correlation is obtained is regarded as the image shift amount, and the found image shift amount is converted into a defocus amount using a conversion coefficient. The image shift amount and defocus amount obtained here indicate the focus state.

The CPU 121 then finds a correction value for actuating the focus actuator 114 based on the found defocus amount, and sends it to the focus actuation circuit 126.

On the other hand, the separated vertical A signal 603 and vertical B signal 604 are subjected to shading correction in the shading correction circuit 1255 in the same manner as in the shading correction circuit 1253. The shading-corrected vertical A signal 603 and vertical B signal 604 are sent to a row interpolation circuit 1256.

The row interpolation circuit 1256 performs interpolation processing in the column direction and sends the interpolated vertical A signal 603 and vertical B signal 604 to a rearrangement processing circuit 1257.

In the first embodiment, the vertical A signals and vertical B signals are only signals output from the pixels 200Gb, which are vertically divided pixels, and in the vertical direction, which is the correlation direction, the signals of the row of the pixels 200R are missing, which raises concerns about a decrease in detection accuracy. Therefore, in order to improve focus detection accuracy in the vertical direction, it is necessary to match the pixel spacing of the focus detection signal with the pixel spacing in the horizontal direction. Therefore, the vertical A signals and vertical B signals corresponding to the positions of the R pixels are vertically interpolated from the vertical A signals and vertical B signals of the adjacent Gb pixels.

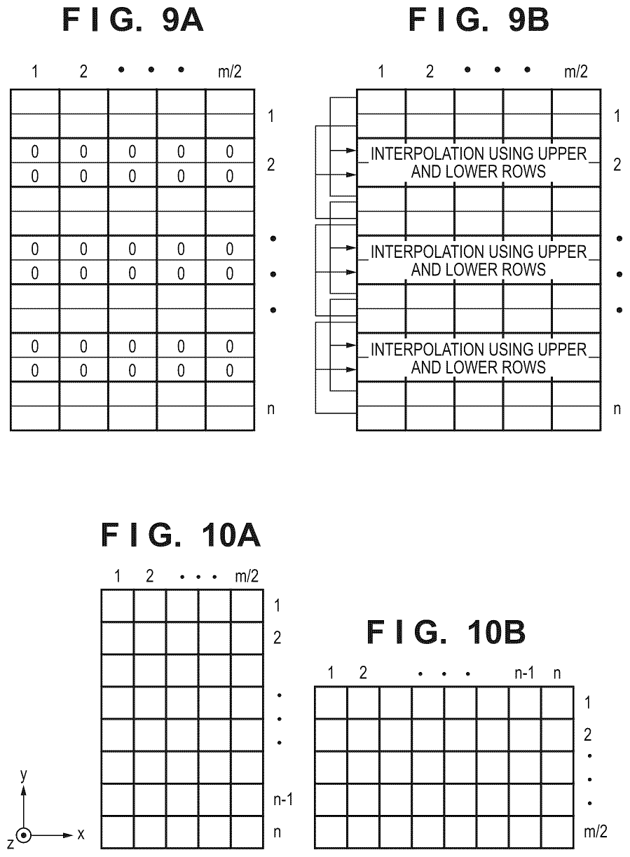

This interpolation method is shown in FIGS. 9A and 9B. After separating the signals of the pixels 200Gb as shown in FIG. 8C, zeros are inserted between the pixels 200Gb (the positions of the signals of the pixels 200R before separating the signals of the pixels 200Gb) as shown in FIG. 9A. Then, as shown in FIG. 9B, the rows of zeros are interpolated with the average values of the signals of adjacent pixels 200Gb above and below.

Note that since only green (G) signals are included in the vertical A and vertical B signals, it is not necessary to generate a Y signal. However, if the vertical A and vertical B signals are output from pixels of multiple colors due to the arrangement of color filters, a Y signal is generated.

The row-interpolated vertical A signals and vertical B signals are sent to the rearrangement processing circuit 1257, where they are rearranged.

The rearrangement processing of array is to be performed so that the pupil division direction of the horizontal A signals and the horizontal B signals and the pupil division direction of the vertical A signals and the vertical B signals coincide with each other, it is more efficient to perform the rearrangement processing of array for the focus detection signal array of the pupil division direction constituted with a smaller number of pixels, and therefore in this embodiment, the rearrangement processing of array is performed on the vertical A signals and the vertical B signals. Since the pupil division directions are the horizontal and vertical directions which are orthogonal to each other, transposition processing is performed as the rearrangement processing.

FIGS. 10A and 10B are diagrams for explaining the transposition processing. FIG. 10A shows the concept of arrangement before transposition, and FIG. 10B shows the concept of arrangement after transposition. The transposition processing is to change an address (i, j) of a signal aᵢⱼ to an address (j, i) and rearranging it. The rearrangement processing may be not only the transposition processing of an array, but also combined processing of rotating and inverting the array.

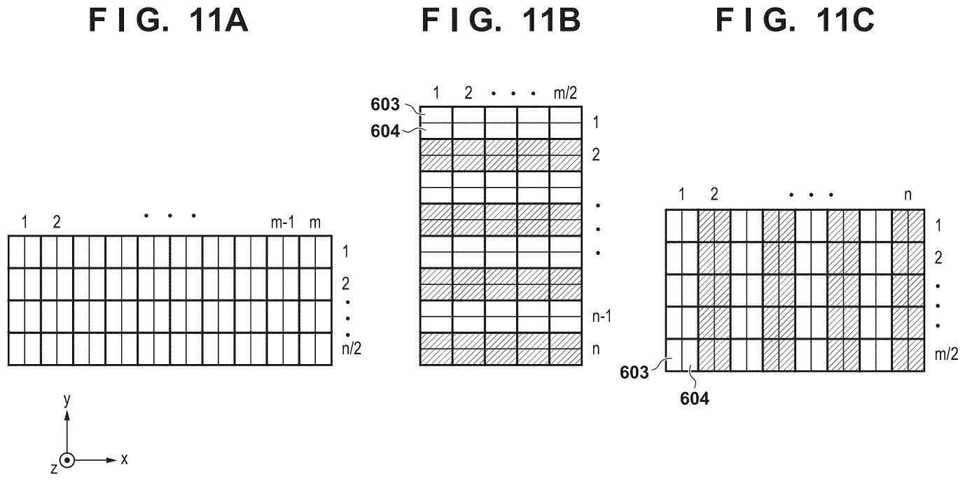

FIGS. 11A to 11C show an example in which an array of the vertical focus detection signals is transposed so as to match the pupil division direction thereof with that of an array of the horizontal focus detection signals in processing. FIG. 11A shows the horizontal Y_{A} signal and horizontal Y_{B} signal, FIG. 11B shows the vertical A signal 603 and vertical B signal 604 before transposition, including signals that have been row-interpolated by the row interpolation circuit 1256, and FIG. 11C shows the vertical A signal 603 and vertical B signal 604 after transposition.

### [Focus Detection Processing]

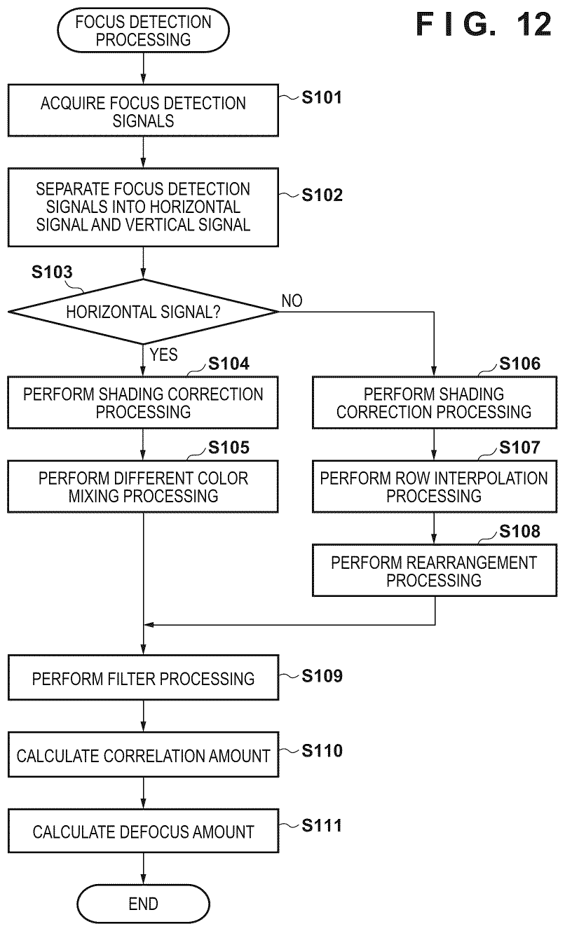

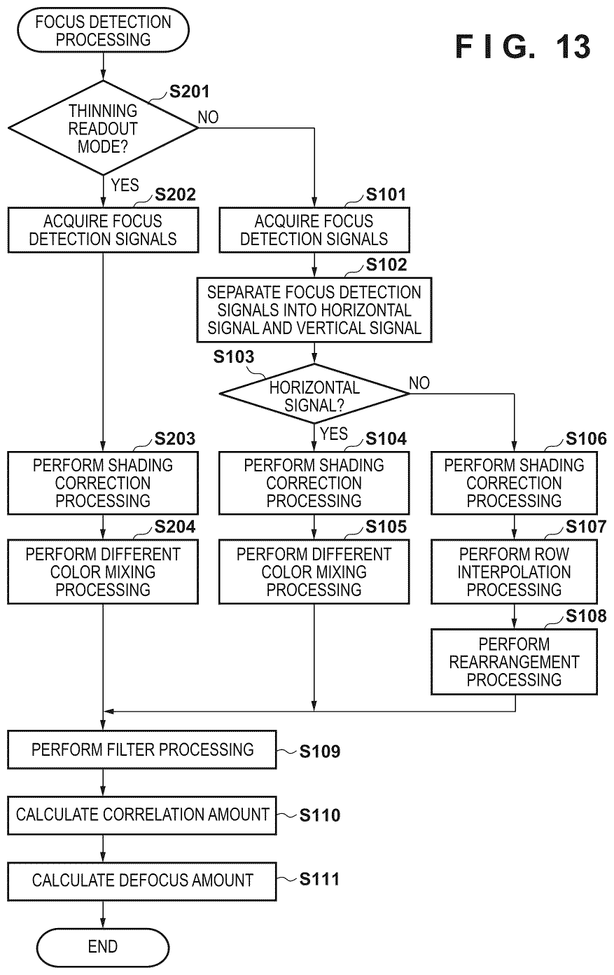

FIG. 12 is a flowchart illustrating the focus detection processing in the first embodiment. The processing shown in FIG. 12 is executed by the image processing circuit 125 and the CPU 121.

First, in step S101, the A signal output from the first focus detection pixel 201 of the image sensor 107 and the B signal output from the second focus detection pixel 202 are acquired and stored in the memory 1251 of the image processing circuit 125.

Next, in step S102, the A signal and B signal stored in the memory 1251 are separated by separation circuit 1252 into the horizontal A signal and horizontal B signal, and the vertical A signal and vertical B signal.

Next, in step S103, the horizontal A signal and the horizontal B signal are output to the shading correction circuit 1253, the vertical A signal and the vertical B signal are output to the shading correction circuit 1255, and shading correction processing is performed in steps S104 and S106, respectively.

Then, in step S105, the different color mixing circuit 1254 performs the above-mentioned different color mixing processing to reduce the data amount of the horizontal A signal and the horizontal B signal, and generates the horizontal Y_{A} signal and the horizontal Y_{B} signal. Note, if the detection signal is of a single color, this processing is not necessary. Also, if a column of a specific color signal is thinned out during reading out the signals, a signal in the thinned column may be interpolated with the average value of the left and right columns to improve the detection accuracy in the horizontal direction. After the different color mixing processing, the process proceeds to step S109.

On the other hand, in step S107, the row interpolation circuit 1256 performs row interpolation processing on the vertical A signal and the vertical B signal as described with reference to FIGS. 9A and 9B. Note that if rows are not thinned out when reading out the vertical focus detection signals (for example, if the division direction of the pixels 200R, 200Gb, and 200B is the vertical direction), a circuit equivalent to the different color mixing circuit 1254 may be provided instead of the row interpolation circuit 1256 to generate the Y signal.

Thereafter, in step S108, the rearrangement processing circuit 1257 performs the rearrangement processing on the vertical A signal and vertical B signal undergone the interpolation processing as described with reference to FIGS. 11A to 11C. This processing in step S108 makes it possible to process the horizontal Y_{A} signal and horizontal Y_{B} signal and the vertical A signal and the vertical B signals using the same processing circuit in the subsequent processing.

In step S109, in order to increase the correlation (degree of coincidence of signals) and improve the focus detection accuracy, the correlation calculation circuit 1258 performs filter processing on the A signal and the B signal using a band-pass filter that extracts a specific frequency band. Examples of band-pass filters include differential filters such as {1, 4, 4, 4, 0, −4, −4, −4, −1} that cut off DC components and perform edge extraction, and additive filters such as {1, 2, 1} that suppress high-frequency noise components.

Next, in step S109, shift processing of relatively shifting the first focus detection signal and the second focus detection signal undergone the filter processing in the pupil division direction is performed, and a correlation amount indicating the degree of coincidence of the signals is calculated.

Let the k^{th} A signal after the filter processing be A(k), the k^{th} B signal be B(k), and the range of the number k corresponding to the focus detection area be W, the shift amount by the shift processing be s, and the shift range of the shift amount s be Γ, then the correlation amount COR is calculated using the formula (1).

$$COR ( s ) = {\sum }_{k ∈ W} \vert A ( k ) - B ( k - s ) \vert , s ∈ Γ \qquad ( 1 )$$

By shifting by the shift amount s, the difference between the k^{th} A signal (k) and the k−s^{th} B signal (k−s) is taken to generate a shift subtraction signal. The absolute value of the generated shift subtraction signal is calculated, and the sum of the shift subtraction signals of the number k within the range W corresponding to the focus detection area is taken to calculate the correlation amount COR(s). If necessary, the correlation amount calculated for each row may be added across multiple rows for each shift amount.

Then, in step S110, a real value of a shift amount at which the correlation amount becomes the minimum is calculated from the correlation amounts by sub-pixel calculation, and this is taken as the image shift amount p. The image shift amount p is then multiplied by a conversion coefficient K to obtain a defocus amount d.

In this way, by performing rearrangement processing of array on the focus detection signals output from vertically divided pixels, it is possible to use the same circuit to perform processing, from filter processing to calculation of the defocus amount, on focus detection signals that have been pupil-divided in both the horizontal and vertical directions.

As described above, according to the first embodiment, it is possible to process focus detection signals divided in different pupil directions using a common circuit, thereby making it possible to reduce the circuit scale.

### Second Embodiment

Next, a second embodiment of the present invention will be described.

In a readout mode in which rows are thinned and read out from the image sensor 107 (for example, an image for flicker detection), if focus detection is to be performed using focus detection signals output from the vertically divided pixels, there is a concern that focus detection performance will be degraded because image shifts in the thinned signals cannot be detected.

In consideration of the above concern, in the second embodiment, in a case where focus detection is performed while switching between multiple readout modes, vertical focus detection is performed in a readout mode in which signals are read out without vertical thinning, and vertical focus detection is not performed in a readout mode in which signals are read out with vertical thinning.

The configuration of the image capturing apparatus is similar to that described with reference to FIGS. 1 to 4 and FIG. 7 in the first embodiment, and therefore explanation thereof will be omitted here. However, in the second embodiment, it is possible to read out signals from the image sensor 107 by control of the image sensor actuation circuit 124 in an all-pixel readout mode in which signals are read out without being thinned out, and in a thinning readout mode in which signals are read out by thinning out rows.

### [Focus Detection Processing]

FIG. 13 is a flowchart showing focus detection processing in the second embodiment. The processing shown in FIG. 13 is executed by the image sensor 107, the image processing circuit 125, and the CPU 121. Among the processes shown in FIG. 13, the same processes as those in FIG. 12 described in the first embodiment are given the same step numbers, and the description thereof will be omitted.

First, in step S201, it is determined whether the mode is the thinning readout mode. If the mode is the thinning readout mode, the process proceeds to step S202, and if the mode is not the thinning readout mode (if the mode is all-pixel readout mode), the process proceeds to step S101, and thereafter, the processes described with reference to FIG. 12 is performed.

In step S202, the horizontal A signal output from the first focus detection pixels 201 of the image sensor 107 and the horizontal B signal output from the second focus detection pixels 202 are acquired and stored in the memory 1251 of the image processing circuit 125.

In step S203, the shading correction circuit 1253 performs shading correction processing on the horizontal A signal and the horizontal B signal to make their intensities uniform.

In step S204, the different color mixing circuit 1254 performs the above-mentioned different color mixing processing to reduce the data amount of the horizontal A signal and the horizontal B signal, generates the horizontal Y_{A} signal and the horizontal Y_{B} signal, and the process proceeds to step S109. Note that if the horizontal A signal and the horizontal B signal are of a single color, the different color mixing processing is not necessary. Also, if columns of a specific color signal are thinned out, the signal of the thinned columns may be interpolated using the average value of the horizontal A signal and the horizontal B signal of the left and right columns, respectively, in order to improve the detection accuracy in the horizontal direction.

In this way, the same circuit is used for the horizontal focus detection signals in the thinning readout mode and the horizontal and vertical focus detection signals in the all-pixel readout mode to perform processing from filtering to calculation of the defocus amount.

As described above, according to the second embodiment, even if focus detection is performed while switching between a readout mode in which focus detection in the vertical direction is performed and a readout mode in which focus detection in the vertical direction is not performed, it is possible to process the focus detection using a common circuit, thereby making it possible to reduce the circuit size.

### Third Embodiment

Next, a third embodiment of the present invention will be described.

In the third embodiment, focus detection is performed using focus detection signals in which the pupil is divided in a third direction (e.g., a direction tilted by 45 degrees) in addition to the horizontal and vertical pupil division directions.

Note that the configuration of the image capturing apparatus is similar to that described with reference to FIGS. 1 and 7 in the first embodiment, and therefore the description thereof will be omitted here. However, the configuration of the image sensor 107 differs from that described with reference to FIGS. 2 to 4, and therefore will be described below.

### [Image Sensor]

The schematic arrangement of the imaging pixels and focus detection pixels of the image sensor 107 in the third embodiment is shown in FIG. 14. FIG. 14 shows the pixel (imaging pixel) arrangement of a two-dimensional CMOS sensor as the image sensor 107 in the third embodiment in a range of 4 columns×4 rows.

A pixel group 700 is composed of 2 rows and 2 columns of pixels, with a pixel 700R having a spectral sensitivity of R (red) arranged in the upper left, a pixel 700Ga having a spectral sensitivity of G (green) arranged in the upper right, a pixel 700Gb arranged in the lower left, and a pixel 700B having a spectral sensitivity of B (blue) arranged in the lower right. Furthermore, each pixel is composed of a first focus detection pixel 701, a second focus detection pixel 702, a third focus detection pixel 703, and a fourth focus detection pixel 704.

By arranging a large number of pixel groups 700 of 2 columns×2 rows shown in FIG. 14 on a plane, it is possible to obtain a shot image and a focus detection signals.

For generating focus detection signals where the pupil division direction is horizontal, the outputs from the first focus detection pixel 701 and the second focus detection pixel 702 of each pixel are added together to generate a horizontal A signal, and the outputs from the third focus detection pixel 703 and the fourth focus detection pixel 704 are added together to generate a horizontal B signal.

In addition, for generating focus detection signals where the pupil division direction is vertical, the outputs from the second focus detection pixel 702 and the third focus detection pixel 703 of each pixel are added together to generate a vertical A signal, and the outputs from the first focus detection pixel 701 and the fourth focus detection pixel 704 are added together to generate a vertical B signal.

Furthermore, for generating focus detection signals where a pupil division direction is at a diagonal angle of 45 degrees, the output from the first focus detection pixel 701 of each pixel is used as an A signal (hereinafter referred to as a “diagonal A signal”), and the output from the third focus detection pixel 703 is used as a B signal (hereinafter referred to as a “diagonal B signal”). Alternatively, the output from the second focus detection pixel 702 may be used as a diagonal A signal, and the output from the fourth focus detection pixel 704 may be used as a diagonal B signal.

Furthermore, by adding up the outputs from the first to fourth focus detection pixels 701 to 704 for each pixel of the image sensor 107, an imaging signal (captured image) with a resolution of N effective pixels is generated.

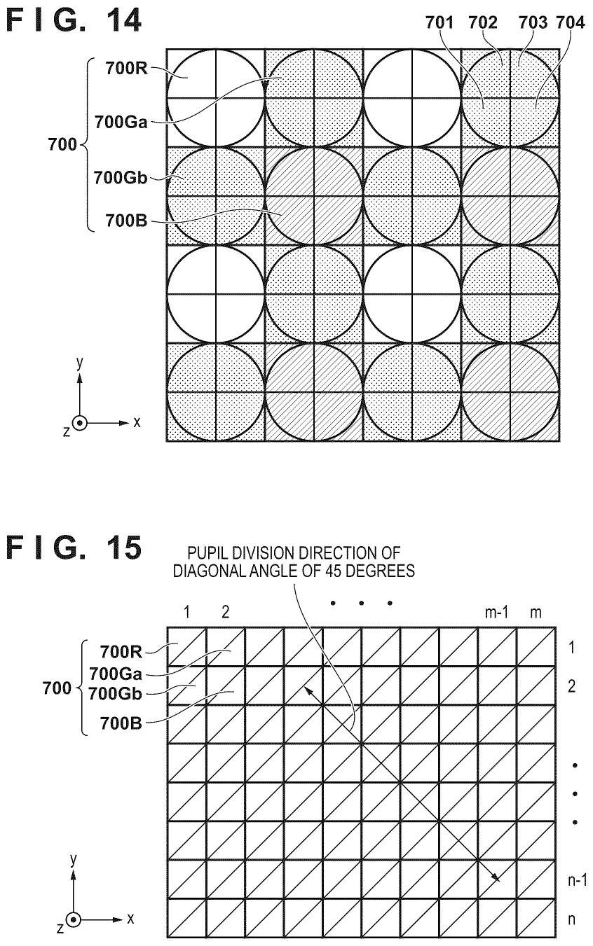

An example of m×n focus detection signals having a pupil division direction of the diagonal angle of 45 degrees, generated in the third embodiment, is shown in FIG. 15. FIG. 15 is a conceptual diagram showing the diagonal A signal output from the second focus detection pixel 702 and the diagonal B signal output from the fourth focus detection pixel 704.

### [Rearrangement Processing]

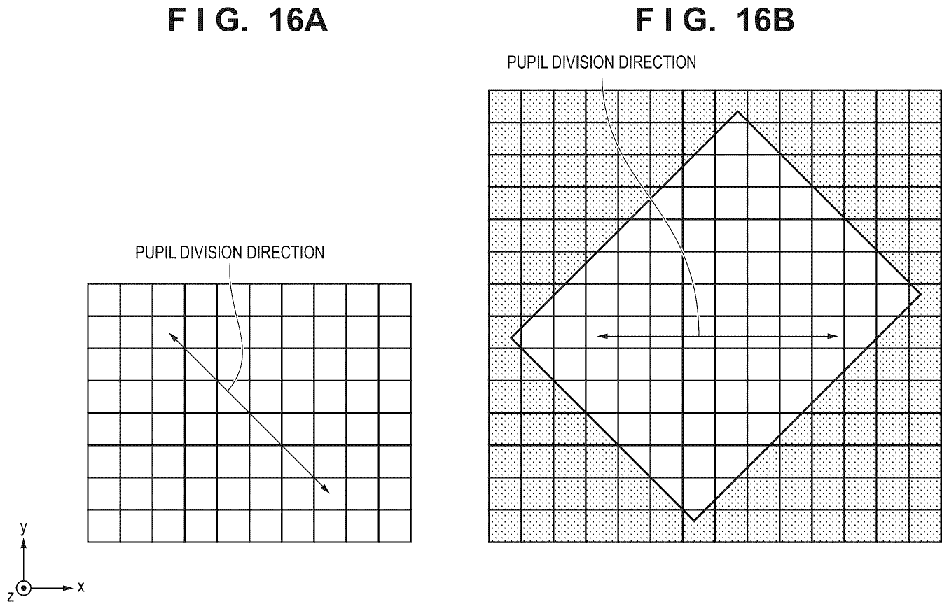

FIGS. 16A and 16B show rearrangement processing for a focus detection signal array with a pupil division direction of the diagonal angle of 45 degrees. FIG. 16A shows the state before the rearrangement processing, and as shown in FIG. 16B, the array is rotated by 45 degrees as the rearrangement processing.

### [Image Processing Circuit]

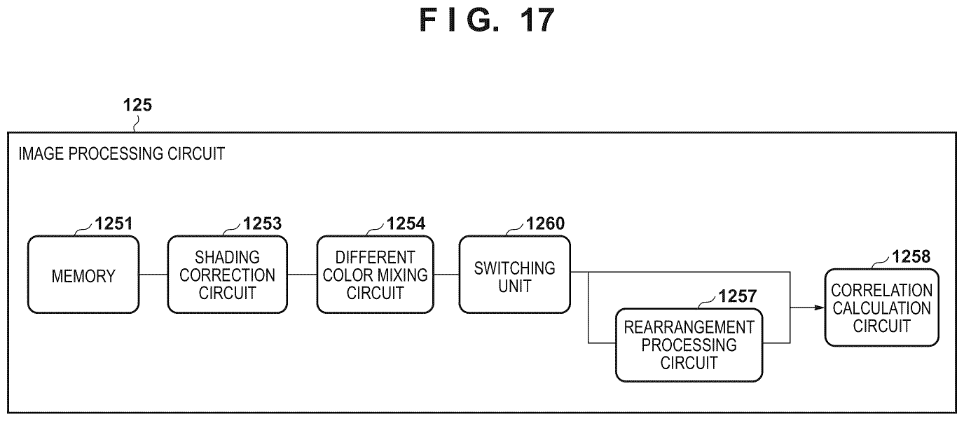

Next, the configuration of the image processing circuit 125 in the third embodiment will be described with reference to FIG. 17. Here, the configuration that performs processing related to correlation calculations for focus detection, among the functions of the image processing circuit 125, will be described. Note that the same reference numbers are used for configurations similar to those shown in FIG. 7.

First, an A signal and a B signal obtained by reading out signals from the image sensor 107 are held in the memory 1251 in the image processing circuit 125. In the third embodiment, horizontal A signal and horizontal B signal, or vertical A signal and vertical B signal, or diagonal A signal and diagonal B signal are obtained depending on the combination of the outputs of the first to fourth focus detection pixels 701 to 704 during reading out signals.

The shading correction circuit 1253 performs shading correction on the input A signal and B signal. After that, the different color mixing circuit 1254 performs different color mixing processing on the shading-corrected A signal and B signal to generate the Y_{A} signal and Y_{B} signal. The generated Y_{A} signal and Y_{B} signal are sent to a switching unit 1260, and if the focus detection direction is the horizontal direction, the signals are output to the correlation calculation circuit 1258. On the other hand, if the focus detection direction is the vertical direction or a diagonal direction of 45 degrees, the Y_{A} signal and Y_{B} signal are output to the rearrangement processing circuit 1257.

In the rearrangement processing circuit 1257, if the focus detection direction is the vertical direction, the signal arrangement is converted as described with reference to FIGS. 11A to 11C, and if the focus detection direction is the diagonal direction of 45 degrees, the signal arrangement is converted as described with reference to FIGS. 16A and 16B, and the rearranged signals are output to the correlation calculation circuit 1258.

### [Focus Detection Processing]

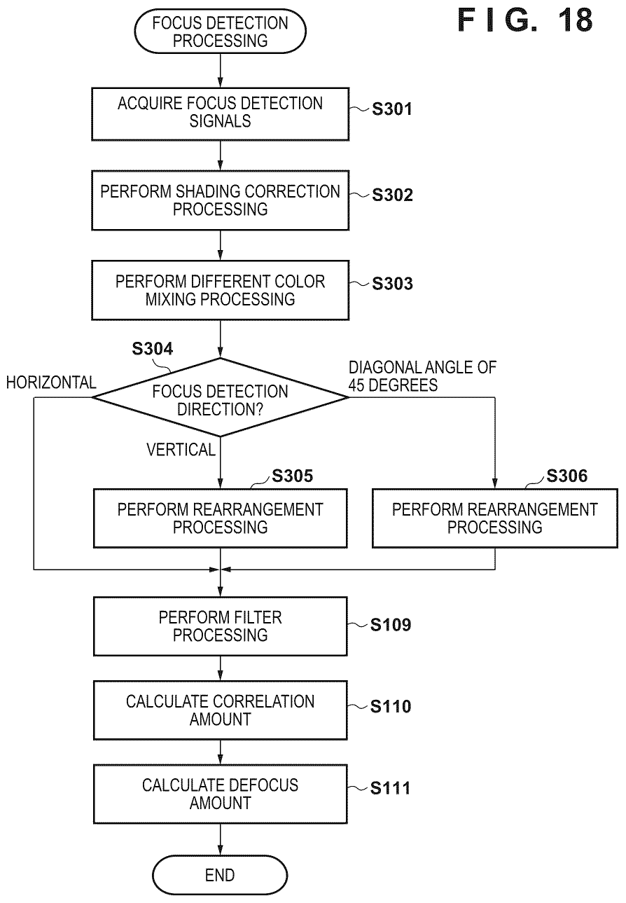

FIG. 18 is a flowchart showing the focus detection processing in the third embodiment. The processing shown in FIG. 18 is executed by the image processing circuit 125 and the CPU 121. Among the processes shown in FIG. 18, the same processes as those in FIG. 12 described in the first embodiment are given the same step numbers, and the description thereof is omitted.

First, in step S301, the A signal and B signal are generated from the signals obtained from the first to fourth focus detection pixels 701 to 704 of each pixel of the image sensor 107, with pupil division in the horizontal direction, vertical direction, or diagonal direction of 45 degrees as described above, and are stored in the memory 1251 of the image processing circuit 125. Then, in step S302, shading correction is performed on the A signal and B signal by the shading correction circuit 1253, and in step S303, the Y_{A} signal and Y_{B} signal are generated by the different color mixing circuit 1254. In the third embodiment, first and second focus detection signals are obtained for every pixel by dividing the pupil in the horizontal direction, vertical direction, or diagonal direction of 45 degrees, and therefore, unlike the first and second embodiments, there is no need to interpolate signals lost due to the separation.

Next, in step S304, the direction in which focus detection is to be performed is determined. If the determined direction is the horizontal direction, the process proceeds to step S108, if the determined direction is the vertical direction, the process proceeds to step S305, and if the determined direction is a diagonal direction of 45 degrees, the process proceeds to step S306.

In step S305, the rearrangement processing is performed on the A signal and B signal by the rearrangement processing circuit 1257, as described with reference to FIGS. 11A to 11C, and the process proceeds to step S108.

In step S306, the rearrangement processing is performed on the A signal and B signal by the rearrangement processing circuit 1257, as described with reference to FIGS. 16A and 16B, and the process proceeds to step S108.

In this way, by performing the rearrangement processing of array on focus detection signals having a pupil division direction other than the horizontal and vertical directions, it becomes possible to perform focus detection calculations using a common circuit.

As described above, according to the third embodiment, it is possible to process focus detection signals divided in different pupil directions using a common circuit, making it possible to reduce the circuit scale.

Note that in the above-mentioned third embodiment, the image sensor 107 having the configuration shown in FIG. 14 generates focus detection signals that are pupil-divided only in the horizontal direction, vertical direction, or diagonal direction of 45 degrees, but the present invention is not limited to this. For example, it is also possible to generate focus detection signals with a plurality of pupil-division directions in a mixed manner by changing the combination of outputs from the focus detection pixels 701 to 704 for each pixel. In that case, focus detection can be performed using the image processing circuit 125 shown in FIG. 7 described in the first embodiment.

### Other Embodiments

The present invention may be applied to a system made up of a plurality of devices, or to an apparatus made up of a single device.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-131462, filed Aug. 10, 2023 which is hereby incorporated by reference herein in its entirety.

What is claimed is:

1. A focus detection apparatus comprising one or more processors and/or circuitry which function as:
an acquisition unit that acquires a pair of focus detection signals having parallax in one of a plurality of different directions for each pixel from signals of a plurality of pixels output from an image sensor;
a separation unit that separates the focus detection signals for each of the directions of the parallax;
a detection unit that detects a focus state based on first focus detection signals, separated by the separation unit, having parallax in a predetermined first direction; and
a rearrangement unit that rearranges second focus detection signals, separated by the separation unit, having parallax in a predetermined second direction which is different from the first direction so as to change the direction of the parallax of the second focus detection signals to the first direction,
wherein the detection unit further detects a focus state based on the second focus detection signals rearranged by the rearrangement unit.

2. The focus detection apparatus according to claim 1, wherein a number of the first focus detection signals arranged in the first direction is greater than a number of the second focus detection signals arranged in the second direction.

3. The focus detection apparatus according to claim 1, wherein the first direction and the second direction are perpendicular to each other.

4. The focus detection apparatus according to claim 1, wherein the rearrangement unit perform rearrangement by transposing an array or by performing combination of rotation and inversion of the array.

5. The focus detection apparatus according to claim 1, wherein the one or more processors and/or circuitry further function as a processing unit that performs shading correction on the second focus detection signals before the rearrangement unit performs rearrangement.

6. The focus detection apparatus according to claim 1, wherein the one or more processors and/or circuitry further function as an interpolation unit that performs interpolation so as to increase the number of the second focus detection signals arranged in the second direction by using the second focus detection signals adjacent to the second focus detection signals in the second direction before the rearrangement unit performs rearrangement.

7. The focus detection apparatus according to claim 1, wherein the one or more processors and/or circuitry further function as a processing unit that performs shading correction on the first focus detection signals and adds the first focus detection signals so as to reduce the number of the first focus detection signals arranged in the second direction.

8. The focus detection apparatus according to claim 1, wherein the image sensor outputs signals in one of an all-pixel readout mode in which signals are read out from all of the pixels constituting the image sensor, and a thinning readout mode in which some of the pixels are thinned out and read out, and
wherein in a case where the signals are read out in the thinning readout mode, the separation unit separates the first focus detection signals from the focus detection signals of the plurality of pixels.

9. A focus detection apparatus comprising one or more processors and/or circuitry which function as:
a generation unit that generates a pair of first focus detection signals having parallax in one of a plurality of different directions for each pixel from signals of a plurality of pixels output from an image sensor;
a detection unit that detects a focus state based on the first focus detection signals in a case where a direction of the parallax is a predetermined first direction; and
a rearrangement unit that rearranges the first focus detection signals to generate second focus detection signals having parallax in the first direction in a case where the direction of the parallax of the first focus detection signals is a second direction which is different from the first direction,
wherein the detection unit further detects a focus state based on the second focus detection signals.

10. The focus detection apparatus according to claim 9, wherein the first direction and the second direction are perpendicular to each other.

11. The focus detection apparatus according to claim 9, wherein the second direction is inclined at 45 degrees with respect to the first direction.

12. An electronic device comprising:
an image sensor; and
a focus detection apparatus comprising one or more processors and/or circuitry which function as:
an acquisition unit that acquires a pair of focus detection signals having parallax in one of a plurality of different directions for each pixel from signals of a plurality of pixels output from an image sensor;
a separation unit that separates the focus detection signals for each of the directions of the parallax;
a detection unit that detects a focus state based on first focus detection signals, separated by the separation unit, having parallax in a predetermined first direction; and
a rearrangement unit that rearranges second focus detection signals, separated by the separation unit, having parallax in a predetermined second direction which is different from the first direction so as to change the direction of the parallax of the second focus detection signals to the first direction,
wherein the detection unit further detects a focus state based on the second focus detection signals rearranged by the rearrangement unit.

13. An electronic device comprising:
an image sensor; and
a focus detection apparatus comprising one or more processors and/or circuitry which function as:
a generation unit that generates a pair of first focus detection signals having parallax in one of a plurality of different directions for each pixel from signals of a plurality of pixels output from an image sensor;
a detection unit that detects a focus state based on the first focus detection signals in a case where a direction of the parallax is a predetermined first direction; and
a rearrangement unit that rearranges the first focus detection signals to generate second focus detection signals having parallax in the first direction in a case where the direction of the parallax of the first focus detection signals is a second direction which is different from the first direction,
wherein the detection unit further detects a focus state based on the second focus detection signals.

14. A focus detection method comprising:
acquiring a pair of focus detection signals having parallax in one of a plurality of different directions for each pixel from signals of a plurality of pixels output from an image sensor;
separating the focus detection signals for each of the directions of the parallax;
detecting a focus state based on separated first focus detection signals having parallax in a predetermined first direction;
rearranging separated second focus detection signals having parallax in a predetermined second direction which is different from the first direction so as to change the direction of the parallax of the second focus detection signals to the first direction; and
detecting a focus state based on the rearrangement second focus detection signals.

15. A focus detection method comprising:
generating a pair of first focus detection signals having parallax in one of a plurality of different directions for each pixel from signals of a plurality of pixels output from an image sensor;
rearranging the first focus detection signals to generate second focus detection signals having parallax in the first direction in a case where the direction of the parallax of the first focus detection signals is a second direction which is different from the first direction;
detecting a focus state based on the first focus detection signals in a case where a direction of the parallax is the first direction, and detecting a focus state based on the second focus detection signals in a case where a direction of the parallax is the second direction.

16. A non-transitory computer-readable storage medium, the storage medium storing a program that is executable by the computer, wherein the program includes program code for causing the computer to function as a focus detection apparatus comprising:
an acquisition unit that acquires a pair of focus detection signals having parallax in one of a plurality of different directions for each pixel from signals of a plurality of pixels output from an image sensor;
a separation unit that separates the focus detection signals for each of the directions of the parallax;
a detection unit that detects a focus state based on first focus detection signals, separated by the separation unit, having parallax in a predetermined first direction; and
a rearrangement unit that rearranges second focus detection signals, separated by the separation unit, having parallax in a predetermined second direction which is different from the first direction so as to change the direction of the parallax of the second focus detection signals to the first direction,
wherein the detection unit further detects a focus state based on the second focus detection signals rearranged by the rearrangement unit.

17. A non-transitory computer-readable storage medium, the storage medium storing a program that is executable by the computer, wherein the program includes program code for causing the computer to function as a focus detection apparatus comprising:
a generation unit that generates a pair of first focus detection signals having parallax in one of a plurality of different directions for each pixel from signals of a plurality of pixels output from an image sensor;
a detection unit that detects a focus state based on the first focus detection signals in a case where a direction of the parallax is a predetermined first direction; and
a rearrangement unit that rearranges the first focus detection signals to generate second focus detection signals having parallax in the first direction in a case where the direction of the parallax of the first focus detection signals is a second direction which is different from the first direction,
wherein the detection unit further detects a focus state based on the second focus detection signals.
